(19) United States
(12) Patent Application Publication
(10) Pub. No.: US 2025/0288941 A1
(43) Pub. Date: Sep. 18, 2025

(54) CARBON DIOXIDE RECOVERY APPARATUS

(71) Applicant: HONDA MOTOR CO., LTD., Tokyo (JP)

(72) Inventors: Subaru MATSUMOTO, Saitama (JP); Masanobu TAKAZAWA, Saitama (JP); Toshiyuki INABA, Saitama (JP); Shumon HOSHINO, Saitama (JP); Keisuke SHIMIZU, Saitama (JP)

(21) Appl. No.: 19/064,634

(22) Filed: Feb. 26, 2025

(30) Foreign Application Priority Data
Mar. 18, 2024 (JP) 2024-042554

(51) Int. Cl. B01D 53/04; B01D 53/62; B01D 53/96

(52) U.S. Cl. CPC B01D 53/0462; B01D 53/62; B01D 53/96; B01D 2257/504

(57) ABSTRACT

The present invention provides a highly energy-efficient carbon dioxide recovery apparatus capable of efficiently execute heating and cooling even when equipment requiring different temperature ranges coexists. The heat exchange device of the carbon dioxide recovery apparatus includes: a heat source low-temperature water circuit that includes a cold water tank that stores cold water cooled by a heat source device, and circulates cold water between the cold water tank and the heat source device; and an equipment heat recovery circuit that branches from a heat source low-temperature water circuit, passes through target equipment for executing an absorbing step or a desorbing step, connects to an inlet side of the heat source device, and returns the cold water having recovered exhaust heat from the target equipment, to the heat source device.

This application is based on and claims the benefit of priority from Japanese Patent Application No. 2024-042554, filed on 18 Mar. 2024, the content of which is incorporated herein by reference.

### BACKGROUND OF THE INVENTION

### Field of the Invention

The present invention relates to a carbon dioxide recovery apparatus.

### Related Art

Conventionally, technologies utilizing heat source devices such as heat pumps in systems that heat or cool target equipment using a heat medium are known. One example of such technology is disclosed in Japanese Unexamined Patent Application, Publication No. 2010-276217. Japanese Unexamined Patent Application, Publication No. 2010-276217 relates to an energy-saving ventilation and air-conditioning system that maintains an air-conditioned space at a predetermined temperature and humidity state.
Patent Document 1: Japanese Unexamined Patent Application, Publication No. 2010-276217

### SUMMARY OF THE INVENTION

Heat source devices such as heat pumps are also utilized in a carbon dioxide recovery apparatus that recovers carbon dioxide by adsorbing carbon dioxide-containing gases, such as air, onto an adsorbent held within a module, and desorbing the adsorbed carbon dioxide by depressurizing and heating the adsorbent.

In a carbon dioxide recovery apparatus, a heating heat medium of high temperature needs to be supplied to the adsorption module for heating, while a cooling heat medium of low temperature also needs to be supplied to recover exhaust heat and to condense steam from various pieces of equipment. However, when there is a significant temperature difference between the heating heat medium and the cooling heat medium, the energy required for heat exchange at the heat source device increases, resulting in a decrease in the coefficient of performance (COP). Therefore, there is room for improvement in terms of energy efficiency in carbon dioxide recovery apparatuses that need to supply heat media to a plurality of devices requiring different temperature ranges.

The present invention aims to provide a highly energy-efficient carbon dioxide recovery apparatus capable of efficiently executing heating and cooling even when equipment requiring different temperature ranges coexists.

(1) The present invention relates to a carbon dioxide recovery apparatus (e.g., carbon dioxide recovery apparatus 1 described later) that includes: a plurality of modules (e.g., module 11 described later) that each internally include an adsorbent (e.g., adsorbent 12 described later) and execute an absorbing step of absorbing carbon dioxide onto the adsorbent by drawing a gas containing carbon dioxide, and a desorbing step of desorbing the carbon dioxide from the adsorbent by heating the adsorbent under reduced ambient pressure; and a heat exchange device (e.g., heat exchange device 70 described later). The heat exchange device includes: a heat pump-type heat source device (e.g., heat source device 81 described later) that heats a heating heat medium and cools a cooling heat medium; a heating heat medium line (e.g., hot water line 112 described later) that supplies the heating heat medium (e.g., hot water) to each of the modules for heating; and a cooling heat medium line (e.g., cold water line 111 described later) that supplies the cooling heat medium (e.g., cold water) for cooling. The heat exchange device includes: a heat source high-temperature water circuit (e.g., heat source high-temperature water circuit 85 described later) that includes a heating heat medium tank (e.g., hot water tank 83 described later) that stores the heating heat medium heated by the heat source device, and circulates the heating heat medium between the heating heat medium tank and the heat source device; a heat source low-temperature water circuit (e.g., heat source low-temperature water circuit 86 described later) that includes a cooling heat medium tank (e.g., cold water tank 82 described later) that stores the cooling heat medium cooled by the heat source device, and circulates the cooling heat medium between the cooling heat medium tank and the heat source device; and an equipment heat recovery circuit (e.g., device heat recovery circuit 87 described later) that branches from the heat source low-temperature water circuit (e.g., heat source low-temperature water circuit 86 described later), passes through target equipment (e.g., vacuum pump 62, carbon dioxide recovery pump 63, and intercooler 64 described later) for executing the absorbing step or the desorbing step, connects to an inlet side of the heat source device within the heat source low-temperature water circuit, and returns the cooling heat medium having recovered exhaust heat from the target equipment, to the heat source device.

(2) In the carbon dioxide recovery apparatus as described in (1), the cooling heat medium having recovered exhaust heat by cooling the modules may be returned to an inlet side of the heat exchange device via the cold water tank.

(3) The carbon dioxide recovery apparatus as described in (1) or (2) may further include a cascade pump (e.g., equipment cooling pump 870 described later) that sends the cooling heat medium to an inlet side of the heat source device.

(4) In the carbon dioxide recovery apparatus as described in (1) or (2), the equipment heat recovery circuit may include the target equipment arranged along each of a plurality of paths branched from the heat source low-temperature water circuit, and collect and return the cooling heat medium having recovered exhaust heat from each of the plurality of target equipment, to the heat source device.

(5) The carbon dioxide recovery apparatus as described in (1) or (2) may further include a control device that controls a path of the equipment heat recovery circuit such that temperature of the cooling heat medium flowing into the heat source device is within a preset appropriate range.

The present invention can provide a highly energy-efficient carbon dioxide recovery apparatus capable of efficiently executing heating and cooling even when equipment requiring different temperature ranges coexists.

### BRIEF DESCRIPTION OF THE DRAWINGS

FIG. 1 is a schematic diagram illustrating the configuration of gas flow in the carbon dioxide recovery apparatus according to one embodiment of the present invention;

FIG. 2 is a schematic diagram illustrating the configuration of liquid flow in the carbon dioxide recovery apparatus according to the present embodiment;

FIG. 3 is a schematic diagram illustrating the configuration of gas flow in the module of the carbon dioxide recovery apparatus according to the present embodiment;

FIG. 4 is a schematic diagram illustrating the configuration of liquid flow in the module of the carbon dioxide recovery apparatus according to the present embodiment;

FIG. 5 is a schematic diagram illustrating the configuration of a heat source circuit of the carbon dioxide recovery apparatus according to the present embodiment;

FIG. 6 is a schematic diagram illustrating the connection positions of the respective lines connected to the hot water tank;

FIG. 7 is a schematic diagram illustrating the connection positions of the respective lines connected to the cold water tank; and

FIG. 8 is a graph schematically illustrating the relationship between the temperature difference of the heat medium introduced into the heat source device and the coefficient of performance (COP).

### DETAILED DESCRIPTION OF THE INVENTION

Hereinafter, embodiments of the present invention will be described with reference to the drawings.

### <Overall Configuration>

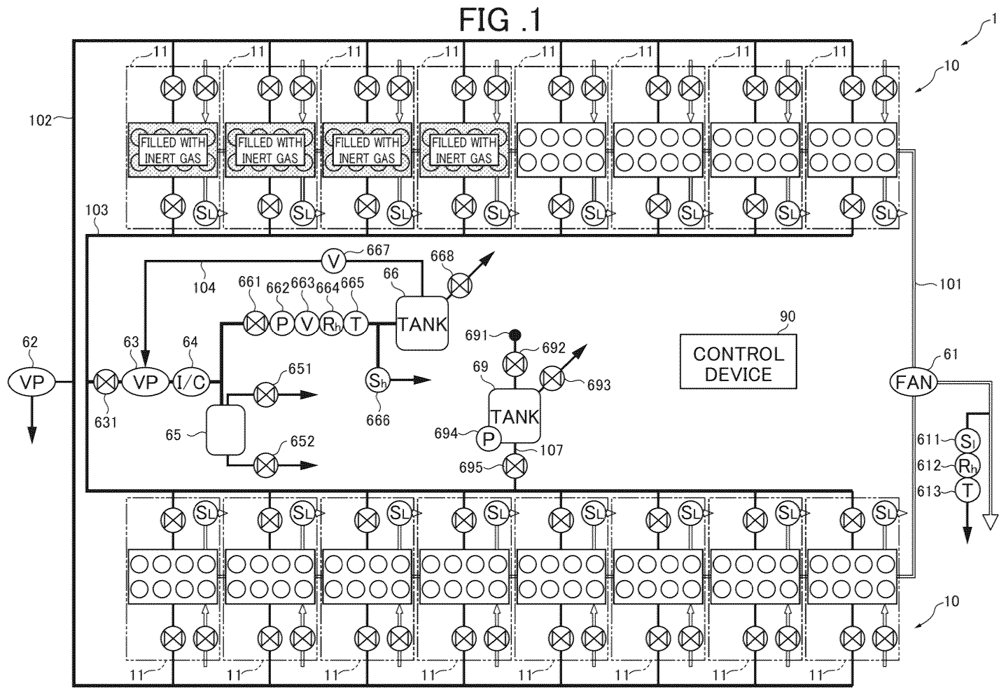

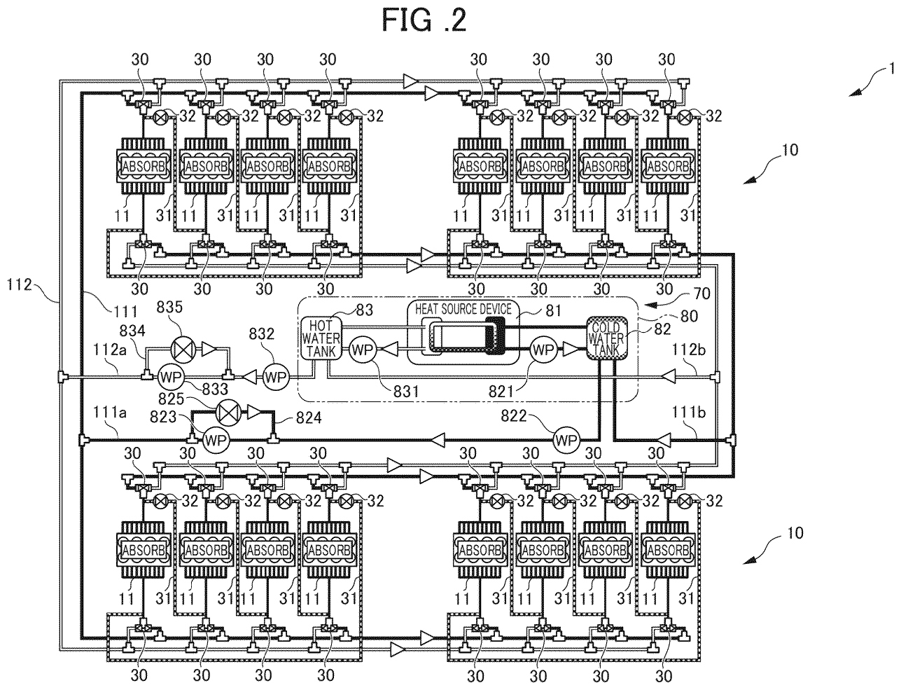

FIG. 1 is a schematic diagram illustrating the configuration of gas flow in a carbon dioxide recovery apparatus 1 according to one embodiment of the present invention. FIG. 2 is a schematic diagram illustrating the configuration of liquid flow in the carbon dioxide recovery apparatus 1 of the present embodiment. FIG. 1 omits a configuration of liquid flow in the carbon dioxide recovery apparatus 1, while FIG. 2 omits a configuration of gas flow in the carbon dioxide recovery apparatus 1.

The carbon dioxide recovery apparatus 1 of the present embodiment is a device applied to a direct air capture (DAC) technology that recovers atmospheric carbon dioxide to reduce the atmospheric carbon dioxide concentration. The carbon dioxide recovered by the carbon dioxide recovery apparatus 1 is either stored underground or reused as fuel or material.

As illustrated in FIGS. 1 and 2, the carbon dioxide recovery apparatus 1 of the present embodiment includes a module unit 10, a fan 61, a vacuum pump 62, a carbon dioxide recovery pump 63, an intercooler 64, a separator 65, a carbon dioxide tank 66, an inert gas tank 69, a heat exchange device 70, and a control device 90.

As illustrated in FIG. 1, the carbon dioxide recovery apparatus 1 includes an adsorption line 101, a vacuum line 102, a carbon dioxide line 103, a circulation line 104, and an inert gas supply line 107, which serve as gas flow paths.

The module unit 10 is configured by a plurality of modules 11, which adsorb carbon dioxide and are arranged in parallel. In the present embodiment, a total of sixteen modules 11 are arranged in a pair of left and right module units 10.

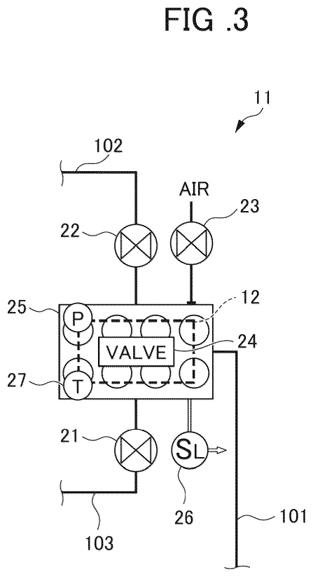

FIG. 3 is a schematic diagram illustrating the configuration of gas flow in the module 11 of the carbon dioxide recovery apparatus 1 of the present embodiment. The module 11 is a carbon dioxide recovery module that includes an adsorbent 12, a first valve 21, a second valve 22, a third valve 23, a fourth valve 24, a pressure sensor 25, a carbon dioxide sensor 26, and a temperature sensor 27.

The adsorbent 12 is arranged inside the module 11 to adsorb carbon dioxide. The adsorbent 12 is a member formed of particulate material that adsorbs carbon dioxide at low temperatures (e.g., in the range of −30° C. to 50° C.) and desorbs (releases) carbon dioxide at high temperatures (e.g., in the range of 50° C. to 110° C.) under conditions of low carbon dioxide concentration in the surrounding. Examples of such adsorbents 12 include solid amine carbon dioxide adsorbents, which are composed of porous materials such as silica supporting amines.

The first valve 21 is an on-off valve arranged at the connection portion between the carbon dioxide line 103, through which carbon dioxide is recovered, and the module 11. The carbon dioxide recovery pump 63 is arranged along the carbon dioxide line 103. The second valve 22 is an on-off valve arranged at the connection portion between the vacuum line 102, along which the vacuum pump 62 is arranged, and the module 11. The third valve 23 is an on-off valve arranged at the inlet, in which atmospheric air is introduced into the module 11. The fourth valve 24 is an on-off valve arranged at the connection portion between the adsorption line 101 and the module 11.

The first valve 21, the second valve 22, the third valve 23, and the fourth valve 24 are all controlled to open and close by the control device 90. The first valve 21, the second valve 22, the third valve 23, and the fourth valve 24 are configured, for example, as normally open butterfly valves.

The pressure sensor 25 measures the internal pressure of the module 11. The carbon dioxide sensor 26 measures the carbon dioxide concentration inside the module 11. The temperature sensor 27 measures the temperature of the adsorbent 12. Measurement information from the pressure sensor 25, the carbon dioxide sensor 26, and the temperature sensor 27 is transmitted to the control device 90.

Returning to FIG. 1, the adsorption line 101 and the fan 61 will be described. The adsorption line 101 branches and connects to each of the modules 11. The fan 61 is arranged at the portion where the branches of the adsorption line 101 converge. When driven, the fan 61 generates a gas flow through the adsorption line 101 from “intake” to “exhaust” toward the modules 11. As a result, atmospheric air is supplied into the modules 11. A carbon dioxide concentration sensor 611, a humidity sensor 612, and a temperature sensor 613 are arranged at the air exhaust portion of the adsorption line 101, and measure the carbon dioxide, humidity, and temperature of the gas exhausted from the adsorption line 101. Measurement information from the carbon dioxide concentration sensor 611, the humidity sensor 612, and the temperature sensor 613 is transmitted to the control device 90.

The vacuum line 102 branches and connects to each of the modules 11. The vacuum pump 62 is arranged at the portion where the branches of the vacuum line 102 converge. When driven, the vacuum pump 62 draws a gas from inside the modules 11 through the vacuum line 102, creating a vacuum or near-vacuum state inside the modules 11.

The carbon dioxide line 103 branches and connects to each of the modules 11. A carbon dioxide recovery pump 63, an intercooler 64, a separator 65, and a carbon dioxide tank 66 are arranged at the portion where the branches of the carbon dioxide line 103 converge.

The carbon dioxide recovery pump 63 generates a suction force to send the carbon dioxide flowing through the carbon dioxide line 103 to the carbon dioxide tank 66. A check valve 631 is arranged upstream of the carbon dioxide recovery pump 63 along the carbon dioxide line 103. As a result, this configuration prevents the gas from flowing back from the intercooler 64 toward the module 11.

The intercooler 64 is an intermediate cooler that cools and separates the gas and liquid from the high-temperature gas containing carbon dioxide recovered from the module 11.

Water separated by the intercooler 64 is recovered by the separator 65. The separator 65 is arranged with a first valve 651 and a second valve 652. The first valve 651 opens and closes the path communicating with the gas phase portion of the separator 65. The second valve 652 opens and closes the path communicating with the liquid phase portion of the separator 65.

The carbon dioxide tank 66 stores carbon dioxide recovered through the carbon dioxide line 103. A tank valve 661 is arranged upstream of the carbon dioxide tank 66 along the carbon dioxide line 103. The tank valve 661 is controlled to open and close by the control device 90. Various sensors, such as a pressure sensor 662, a flow rate sensor 663, a humidity sensor 664, a temperature sensor 665, and a carbon dioxide concentration sensor 666, are arranged between the tank valve 661 and the carbon dioxide tank 66 along the carbon dioxide line 103.

In addition to the carbon dioxide line 103, the carbon dioxide tank 66 is connected to a circulation line 104 for returning the ballast to the carbon dioxide recovery pump 63. A flow rate sensor 667 is arranged along the circulation line 104. The carbon dioxide tank 66 is arranged with a pressure release valve 668 that releases pressure when the pressure exceeds a predetermined level.

Next, the inert gas tank 69 will be described. The inert gas tank 69 stores the inert gas (N₂) supplied from an N₂ gas cylinder 691 at a pressure of a predetermined level or higher (e.g., 980 kPa). A gas cylinder valve 692 is arranged between the inert gas tank 69 and the N₂ gas cylinder 691. The inert gas tank 69 is arranged with a pressure release valve 693 that releases pressure when the pressure exceeds a predetermined level. A pressure sensor 694 is arranged inside the inert gas tank 69. Information of pressure measured by the pressure sensor 694 is transmitted to the control device 90.

The inert gas tank 69 is connected to the carbon dioxide line 103 via the inert gas supply line 107. An inert gas valve 695 is arranged along the inert gas supply line 107. The inert gas valve 695 is controlled to open and close by the control device 90.

Referring to FIG. 2, the heat exchange device 70 will be described. When the module 11 of the module unit 10 executes a desorbing step, the heat exchange device 70 supplies thermal energy for heating the module 11 to a predetermined temperature. The heat exchange device 70 also recovers unnecessary thermal energy when each module 11 executes an absorbing step.

The heat exchange device 70 of the present embodiment includes a heat source circuit 80, a cold water line 111, a hot water line 112, a three-way valve 30, a bypass path 31, and a bypass valve 32.

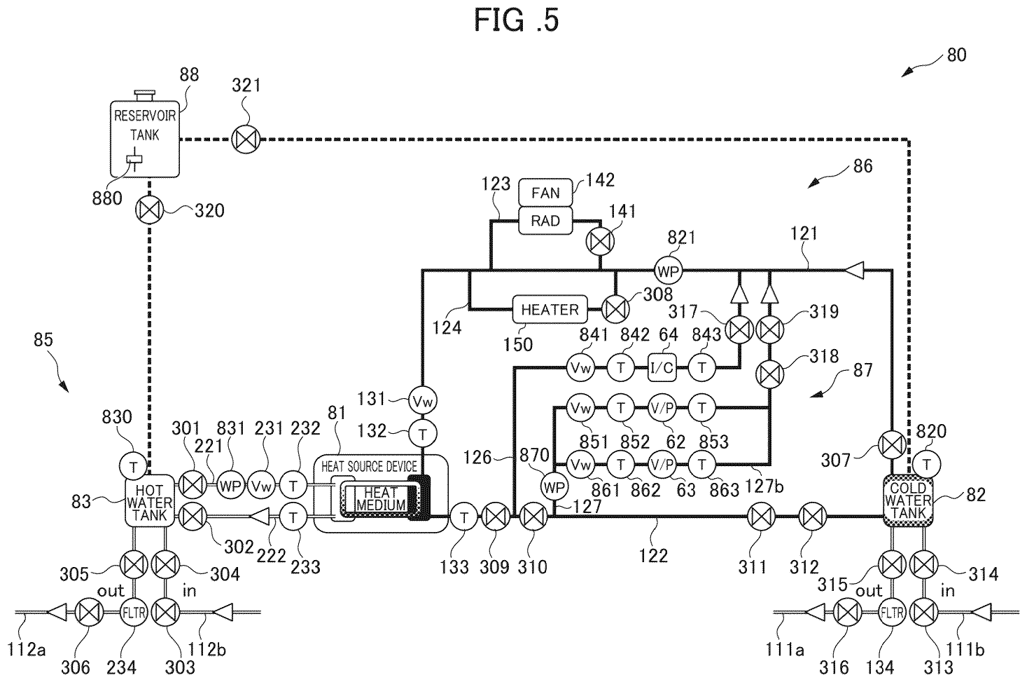

The heat source circuit 80 primarily includes a heat source device 81, a cold water tank 82, and a hot water tank 83, and executes heat exchange between the cooling heat medium flowing through the cold water line 111 and the heating heat medium flowing through the hot water line 112. The heat transfer occurring in the heat source circuit 80 cools the heat medium flowing through the cold water line 111, and heats the heat medium flowing through the hot water line 112. The heat medium is, for example, a liquid such as water. The detailed configuration of the heat source circuit 80 will be described later with reference to FIG. 5.

The cold water line 111 is a pipeline for circulating cold water serving as a cooling heat medium. The cold water line 111 branches and connects to upstream and downstream of each module 11, thereby connecting the cold water tank 82 to each module 11. A part of the cold water line 111 connected to upstream of each module 11 is referred to as a cold water supply line 111a, and a part connected to downstream of each module 11 is referred to as a cold water return line 111b.

The cold water supply line 111a is connected in parallel to the plurality of modules 11, allowing cold water to be supplied concurrently to each module 11. A first cold water circulation pump 822 and a second cold water circulation pump 823 are arranged along the cold water supply line 111a. Cascade pumps, for example, are used for the first cold water circulation pump 822 and the second cold water circulation pump 823.

A circulation line 824, returning from downstream to upstream of the second cold water circulation pump 823, is arranged along the cold water supply line 111a. A safety valve 825 is arranged along the circulation line 824. When the pressure within the system of the second cold water circulation pump 823 and the cold water line 111 exceeds a predetermined level, the safety valve 825 relieves pressure to suppress further pressure increase. The safety valve 825, which relieves pressure in the event of an abnormal pressure within the system of the cold water line 111, is arranged in parallel with the second cold water circulation pump 823, thereby allowing the second cold water circulation pump 823 to achieve both high-flow circulation and safe operation.

The cold water return line 111b is also connected in parallel to the plurality of modules 11, allowing cooled cold water to be recovered concurrently from each module 11.

The hot water line 112 is a pipeline for circulating hot water serving as a heating heat medium. The hot water line 112 branches and connects to upstream and downstream of each module 11, thereby connecting the hot water tank 83 to each module 11. A part of the hot water line 112 connected to upstream of each module 11 is referred to as a hot water supply line 112a, and a part connected to downstream of each module 11 is referred to as a hot water return line 112b.

The hot water supply line 112a is connected in parallel to the plurality of modules 11, allowing hot water to be supplied concurrently to each module 11. A first hot water circulation pump 832 and a second hot water circulation pump 833 are arranged along the hot water supply line 112a. Cascade pumps, for example, are used for the first hot water circulation pump 832 and the second hot water circulation pump 833. By utilizing cascade pumps that generate a significant amount of heat during operation, the heat medium passing through the first hot water circulation pump 832 and the second hot water circulation pump 833 can be further heated.

A circulation line 834, returning from downstream to upstream of the second hot water circulation pump 833, is arranged along the hot water supply line 112a. A safety valve 835 is arranged along the circulation line 834. When the pressure within the system of the second hot water circulation pump 833 and the hot water line 112 exceeds a predetermined level, the safety valve 835 relieves pressure to suppress further pressure increase. The safety valve 835, which relieves pressure in the event of an abnormal pressure within the system of the hot water line 112, is arranged in parallel with the second hot water circulation pump 833, allowing the second hot water circulation pump 833 to achieve both high-flow circulation and safe operation.

The hot water return line 112b is also connected in parallel to the plurality of modules 11, allowing heated hot water to be recovered concurrently from each module 11.

The three-way valve 30 is connected to the cold water line 111, the hot water line 112, and the module 11. The three-way valve 30 is arranged both upstream and downstream of the module 11. The three-way valve 30 is configured to selectively switch the flow path between a cold water connection state, in which the cold water line 111 is connected to the module 11, a hot water connection state, in which the hot water line 112 is connected to the module 11, and a shut-off state, in which the connection between the cold water line 111, the hot water line 112, and the module 11 is shut off.

The flow path switching by the three-way valve 30 is controlled by the control device 90. The heat medium is introduced into the module 11 through the three-way valve 30 arranged upstream, and the heat medium is returned to the heat source device 81 through the three-way valve 30 arranged downstream.

The bypass path 31 is a flow path that allows the heat medium to be transferred between the modules 11. The bypass path 31 connects between two modules 11. The modules 11 connected by the bypass path 31 may be adjacent modules 11, or modules 11 positioned at a distance from each other.

The bypass valve 32 is arranged in the bypass path 31. The bypass valve 32 is arranged in each of the bypass paths 31. The bypass valve 32 is controlled to open and close by the control device 90.

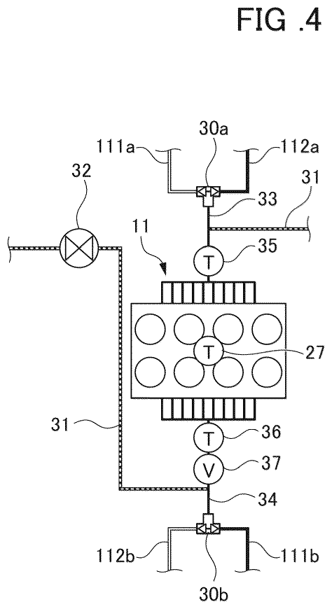

FIG. 4 is a schematic diagram illustrating the configuration of liquid flow in the module 11 of the carbon dioxide recovery apparatus 1 of the present embodiment. In the following description, the three-way valve 30 arranged upstream of the module 11 is referred to as a three-way valve 30a, and the three-way valve 30 arranged downstream of the module 11 is referred to as a three-way valve 30b.

As illustrated in FIG. 4, the module 11 includes an inlet flow path 33 connected to the inlet for the heat medium to flow in, and an outlet flow path 34 connected to the outlet for the heat medium to flow out. The bypass path 31 is connected to the outlet flow path 34 of the module 11 and to the inlet flow path 33 of another module 11.

The three-way valve 30a is arranged at the upstream end of the inlet flow path 33, while the three-way valve 30b is arranged at the downstream end of the outlet flow path 34. In the hot water connection state, the three-way valve 30a is connected to the hot water supply line 112a, and the three-way valve 30b is connected to the hot water return line 112b. In the cold water connection state, the three-way valve 30a is connected to the cold water supply line 111a, and the three-way valve 30b is connected to the cold water return line 111b.

The three-way valve 30a and the three-way valve 30b are configured to be capable of adjusting the flow rate. This flow rate adjustment function allows the hot water flow rate to be regulated in the hot water connection state, and the cold water flow rate to be regulated in the cold water connection state.

A temperature sensor 35 is arranged in the inlet flow path 33. A temperature sensor 36 and a flow rate sensor 37 are arranged in the outlet flow path 34. Measurement information from the temperature sensor 35, the temperature sensor 36, and the flow rate sensor 37 is transmitted to the control device 90.

Next, the control device 90 will be described. The control device 90 controls the operation of each component of the carbon dioxide recovery apparatus 1. The control device 90 controls operations such as activation and deactivation of the devices used for absorbing or desorbing carbon dioxide. Since the plurality of modules 11 repeatedly execute adsorption and desorption in time sequence, the control device 90 selectively controls the timing for supplying the heat medium to heat or cool the modules 11.

The control device 90 executes open/close control of the first valve 21, the second valve 22, the third valve 23, and the fourth valve 24 which are provided in each module 11, and executes open/close control of each bypass valve 32. The control device 90 executes drive control of the fan 61, the vacuum pump 62, the carbon dioxide recovery pump 63, the first cold water circulation pump 822, the second cold water circulation pump 823, the first hot water circulation pump 832, and the second hot water circulation pump 833, and executes open/close control of the safety valve 825 and the safety valve 835.

The control device 90 is a computer that includes components such as a CPU (Central Processing Unit), ROM (Read Only Memory), and RAM (Random Access Memory). The control device 90 may be configured by a single unit or a plurality of units. The control device 90 may also be configured using electrical circuits such as relays.

### <Carbon Dioxide Recovery>

Next, the control for recovering carbon dioxide by the control device 90 will be described. The carbon dioxide recovery apparatus 1 alternately executes an absorbing step of absorbing carbon dioxide in a gas such as intake atmospheric air onto the adsorbent 12 inside the module 11, and a desorbing step of desorbing the carbon dioxide adsorbed on the adsorbent 12, thereby removing and recovering carbon dioxide from the air, and storing the desorbed carbon dioxide in the carbon dioxide tank 66.

The absorbing step is a step of absorbing carbon dioxide onto the adsorbent 12 inside the module 11. During the absorbing step, the third valve 23 and the fourth valve 24 of the module 11 are opened, while the first valve 21 and the second valve 22 are closed. In conjunction with the open/close control of the valve, the heat exchange device 70 controls the three-way valve 30a and the three-way valve 30b to be switched to the cold water connection state, whereby cold water flows into the module 11 to cool the adsorbent 12 inside the module 11. The fan 61 is driven, and a gas flow from upstream to downstream is generated, drawing in the gas containing carbon dioxide (e.g., atmospheric air) through the third valve 23. The intake gas passes through the adsorbent 12 inside the module 11. In this case, the interior of the module 11 is maintained at room temperature (25° C.) due to cooling by the cold water, and carbon dioxide in the gas is adsorbed onto the adsorbent 12. Gases other than carbon dioxide, such as nitrogen and oxygen, are discharged outside the carbon dioxide recovery apparatus 1 through the fourth valve 24 and the adsorption line 101.

The desorbing step is a step of desorbing carbon dioxide from the adsorbent 12 inside the module 11. In the desorbing step, the first valve 21, the third valve 23, and the fourth valve 24 of the module 11 are closed, while the second valve 22 is opened. The vacuum pump 62 operates to draw a gas from the inside of the module 11, reducing the pressure to create a vacuum or near-vacuum state. In conjunction with the open/close control of the valve, the heat exchange device 70 controls the three-way valve 30a and the three-way valve 30b to be switched to the hot water connection state, thereby allowing hot water to flow into the module 11, supplying thermal energy, raising the temperature of the adsorbent 12 inside the module 11. By controlling the temperature of the adsorbent 12 to rise, the adsorbent 12 is heated to a predetermined temperature (e.g., 80° C.) sufficient for the desorbing step, whereby the carbon dioxide adsorbed onto the adsorbent 12 is desorbed. Subsequently, the second valve 22, the third valve 23, and the fourth valve 24 are closed, while the first valve 21 is opened, and the carbon dioxide recovery pump 63 is driven, whereby the desorbed carbon dioxide is transferred through the carbon dioxide line 103 and stored in the carbon dioxide tank 66. In the present embodiment, each process is controlled such that twelve out of sixteen modules 11 execute the absorbing step, and the remaining four modules execute the desorbing step.

### <Heat Source Circuit>

Next, the detailed configuration of the heat source circuit 80 will be described with reference to FIG. 5. FIG. 5 is a schematic diagram illustrating the configuration of the heat source circuit 80 in the carbon dioxide recovery apparatus 1 of the present embodiment.

As illustrated in FIG. 5, the heat source circuit 80 of the present embodiment includes a heat source device 81, a heat source high-temperature water circuit 85 including a hot water tank 83, a heat source low-temperature water circuit 86 including a cold water tank 82, and a reservoir tank 88.

The heat source device 81 cools the heat medium introduced from the cold water tank 82, and heats the medium introduced from the hot water tank 83. The heat source device 81 compresses and expands a gas via a heat pump, generating thermal energy for cooling and heating, and transferring the generated thermal energy to execute cooling and heating.

The heat source high-temperature water circuit 85 circulates hot water between the hot water tank 83 and the heat source device 81. The heat source high-temperature water circuit 85 includes the hot water tank 83, a hot water side heat source supply line 221, and a hot water side heat source return line 222.

The hot water tank 83 is a heat storage device with a thermal insulation function, capable of storing the heat medium. The capacity of the hot water tank 83 is preferably at least five times the maximum discharge flow rate of a hot water side circulation pump 831, which will be described later. The capacity of the hot water tank 83 is set larger than the flow rate of the heat medium, thereby allowing for suppressing fluctuations in temperature of the hot water (heat medium) within a predetermined temperature range (e.g., within +5° C.) during heat load variations. In other words, the hot water tank 83 functions as a buffer for fluctuations in heat load.

A temperature sensor 830 for measuring the temperature of the heat medium is arranged inside the hot water tank 83. Measurement results from the temperature sensor 830 are output to the control device 90. The hot water tank 83 is connected to the heat source device 81 via the hot water side heat source supply line 221 and the hot water side heat source return line 222.

The hot water side heat source supply line 221 is a path, through which the heat medium flows from the hot water tank 83 to the heat source device 81. A valve 301, a hot water side circulation pump 831, a flow rate sensor 231, and a temperature sensor 232 are arranged in this order from upstream of the hot water side heat source supply line 221. The hot water side circulation pump 831 is configured by, for example, a centrifugal pump or the like, and circulates the heat medium between the hot water tank 83 and the heat source device 81. The flow rate sensor 231 measures the flow rate of the heat medium flowing into the heat source device 81, and outputs the measurement results to the control device 90. The temperature sensor 233 measures the temperature of the heat medium flowing into the heat source device 81, and outputs the measurement results to the control device 90.

The hot water side heat source return line 222 is a path, through which the heat medium flows from the heat source device 81 to the hot water tank 83. A temperature sensor 233 and a valve 302 are arranged in this order from upstream of the hot water side heat source return line 222. The temperature sensor 233 measures the temperature of the hot water discharged from the heat source device 81, and outputs the measurement results to the control device 90.

The hot water tank 83 is connected to the hot water supply line 112a and the hot water return line 112b. A valve 305, a water filter 234, and a valve 306 are arranged near the hot water tank 83 along the hot water supply line 112a. Valves 303 and 304 are arranged along the hot water return line 112b.

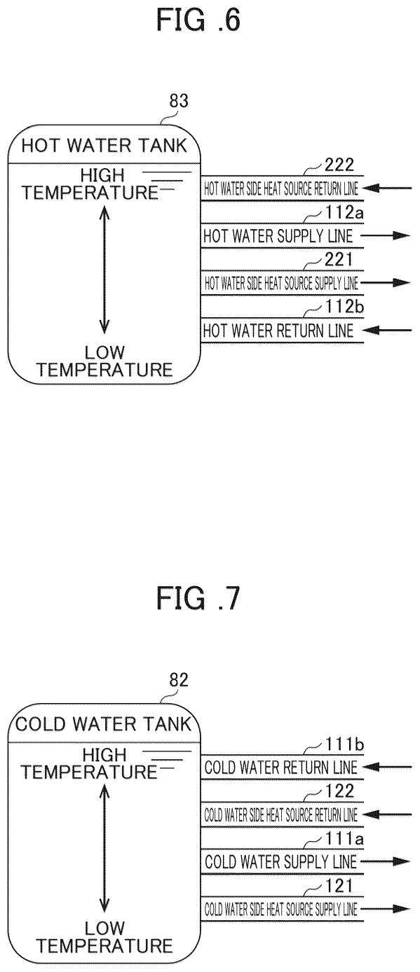

The connection positions (port positions) of each line connected to the hot water tank 83 is preferably set in consideration of the temperature stratification of the heat medium (hot water) stored in the hot water tank 83. FIG. 6 is a schematic diagram illustrating the connection positions of each line connected to the hot water tank 83.

As illustrated in FIG. 6, the hot water stored in the hot water tank 83 forms a temperature stratification, with higher temperatures at the upper portion and lower temperatures at the lower portion. The connection positions of each line in the hot water tank 83 are set in the order of the hot water side heat source return line 222, the hot water supply line 112a, the hot water side heat source supply line 221, and the hot water return line 112b, from the highest to the lowest position.

The hot water side heat source return line 222 is a pipeline, through which hot water (for example, 82° C.) heated by the heat source device 81 is returned to the highest temperature region at the highest position of the temperature stratification. The hot water supply line 112a is connected to the highest position next to the connection point of the hot water side heat source return line 222. Therefore, the hot water heated by the heat source device 81 is sent upstream of the module 11 while maintaining a high temperature (for example, 80° C.) without significantly lowering the temperature.

The hot water side heat source supply line 221 is a pipeline for sending hot water to be heated to the heat source device 81, and connected to the highest position next the connection point of the hot water supply line 112a. As a result, the high-temperature hot water can be sent through the hot water supply line 112a, while the hot water side heat source supply line 221 can send hot water maintained at a relatively high temperature (for example, 75° C.) to the heat source device 81. The hot water return line 112b is a pipeline for returning the relatively low-temperature hot water (for example, 72° C.) that has heated the module 11. The hot water return line 112b is connected at the lowest position, thereby allowing for suppressing the mixing of low-temperature hot water into the hot water supply line 112a that requires high temperature.

Next, returning to FIG. 5, the heat source low-temperature water circuit 86 will be described. The heat source low-temperature water circuit 86 circulates cold water between the cold water tank 82 and the heat source device 81. The heat source low-temperature water circuit 86 includes the cold water tank 82, a cold water side heat source supply line 121, and a cold water side heat source return line 122.

The cold water tank 82 is a heat storage device with a thermal insulation function, capable of storing the heat medium. The capacity of the cold water tank 82 is preferably at least five times the maximum discharge flow rate of the cold water side circulation pump 821, which will be described later. The capacity of the cold water tank 82 is set larger than the flow rate of the heat medium, thereby allowing for suppressing fluctuations in the water temperature of the cold water (heat medium) within a predetermined temperature range (e.g., within +5° C.) during heat load variations. In other words, the cold water tank 82 functions as a buffer for heat load fluctuations.

A temperature sensor 820 for measuring the temperature of the heat medium is arranged inside the cold water tank 82. Measurement results from the temperature sensor 820 are output to the control device 90. The cold water tank 82 is connected to the heat source device 81 via the cold water side heat source supply line 121 and the cold water side heat source return line 122.

The cold water side heat source supply line 121 is a path, through which the heat medium flows from the cold water tank 82 to the heat source device 81. A valve 307, a cold water side circulation pump 821, a flow rate sensor 131, and a temperature sensor 132 are arranged along the cold water side heat source supply line 121. The cold water side circulation pump 821 is configured by, for example, a centrifugal pump or the like, and circulates the heat medium between the cold water tank 82 and the heat source device 81. The flow rate sensor 131 measures the flow rate of the heat medium flowing into the heat source device 81, and outputs the measurement results to the control device 90. The temperature sensor 132 measures the temperature of the heat medium flowing into the heat source device 81, and outputs the measurement results to the control device 90.

A radiator bypass line 123 for cooling the heat medium and a heater bypass line 124 for heating the heat medium are connected to the cold water side heat source supply line 121. The radiator bypass line 123 and the heater bypass line 124 are temperature adjustment circuits that adjust the temperature of the heat medium introduced into the heat source device 81 to an operable temperature in response to variations in the outside air temperature and the heat load.

The radiator bypass line 123 is connected between the cold water side circulation pump 821 and the flow rate sensor 131 along the cold water side heat source supply line 121. A valve 141 and a radiator fan 142 are arranged along the radiator bypass line 123. The valve 141 can open and close the flow path, and adjust the flow rate, based on the control signals from the control device 90. The radiator fan 142 is a heat dissipation device that cools the heat medium passing through the radiator bypass line 123. Cooling of the heat medium by the radiator bypass line 123 is primarily executed during high-temperature periods, such as in summer. The cooling of the heat medium through the radiator bypass line 123 is controlled to ensure that the temperature of the cold water introduced into the heat source device 81 is maintained at or below a preset threshold.

The heater bypass line 124 is connected between the cold water side circulation pump 821 and the flow rate sensor 131 along the cold water side heat source supply line 121, and is located inside the radiator bypass line 123. A valve 308 and a heater 150 are arranged along the heater bypass line 124. The heater 150 operates based on the control signals from the control device 90 or relay drive signals, and heats the heat medium flowing through the heater bypass line 124. Heating of the heat medium by the heater bypass line 124 is primarily executed during low-temperature periods, such as during startup in winter. The heating of the heat medium through the heater bypass line 124 is controlled to ensure that the temperature of the heat medium introduced into the heat source device 81 is maintained at or above a preset threshold.

The cold water side heat source return line 122 is a path, through which the heat medium flows from the heat source device 81 to the cold water tank 82. A temperature sensor 133, a valve 309, a valve 310, a valve 311, and a valve 312 are arranged in this order from upstream of the cold water side heat source return line 122. The temperature sensor 133 measures the temperature of the cold water discharged from the heat source device 81, and outputs the measurement results to the control device 90.

The cold water tank 82 is connected to the cold water supply line 111a and the cold water return line 111b. A valve 315, a water filter 134, and a valve 316 are arranged near the cold water tank 82 along the cold water supply line 111a. Valves 313 and 314 are arranged along the cold water return line 111b.

The connection positions (port positions) of each line connected to the cold water tank 82 is preferably set in consideration of the temperature stratification of the heat medium (cold water) stored in the cold water tank 82. FIG. 7 is a schematic diagram illustrating the connection positions of each line connected to the cold water tank 82.

As illustrated in FIG. 7, the cold water stored in the cold water tank 82 forms a temperature stratification, with higher temperatures at the upper portion and lower temperatures at the lower portion. The connection positions of each line in the cold water tank 82 are set in the order of the cold water return line 111b, the cold water side heat source return line 122, the cold water supply line 111a, and the cold water side heat source supply line 121, from the highest to the lowest position.

The cold water return line 111b is a pipeline for returning the relatively highest-temperature cold water (for example, 36° C.) that has cooled the module 11. The cold water return line 111b is connected to the highest position, thereby allowing for suppressing the mixing of higher-temperature cold water with the cold water sent from the cold water supply line 111a. The cold water side heat source return line 122 is a pipeline for returning cold water (e.g., 30° C.) cooled by the heat source device 81, and connected to the highest position next the connection point of the cold water return line 111b. The cold water returned through the cold water side heat source return line 122 moves toward the lower layer side of the temperature stratification.

The cold water supply line 111a is connected to the highest position next to the connection point of the cold water side heat source return line 122, allowing the cold water cooled by the heat source device 81 to be sent upstream of the module 11, while maintaining a low temperature (e.g., 31° C.) without significantly increasing the temperature. The cold water side heat source supply line 121 is connected to the lowest position, and sends low-temperature cold water (e.g., 33° C.), which was not sent to the module 11 from the cold water supply line 111a, to the heat source device 81.

Next, returning to FIG. 5, an equipment heat recovery circuit 87, which cools target equipment such as the intercooler 64, the vacuum pump 62, and the carbon dioxide recovery pump 63 included in the heat source low-temperature water circuit 86, while raising the temperature of the heat medium, will be described.

The equipment heat recovery circuit 87 is connected in parallel to the heat source low-temperature water circuit 86. The equipment heat recovery circuit 87 of the present embodiment includes: a first equipment heat cooling line 126 for exchanging heat with the intercooler 64; and a second equipment heat cooling line 127 for exchanging heat with the vacuum pump 62 and the carbon dioxide recovery pump 63.

The first equipment heat cooling line 126 has the upstream end thereof connected to the cold water side heat source return line 122, and the downstream end thereof connected to the cold water side heat source supply line 121. In the present embodiment, the upstream end of the first equipment heat cooling line 126 is connected between the valve 309 and the valve 310 along the cold water side heat source return line 122. The downstream end of the first equipment heat cooling line 126 is connected between the valve 307 and the cold water side circulation pump 821 along the cold water side heat source supply line 121.

The first equipment heat cooling line 126 is connected to the intercooler 64 generating steam condensation heat, and cools the intercooler 64 using cold water to recover exhaust heat from the steam condensation heat. The cold water, in the state of being heated through heat exchange with the intercooler 64, is sent to the cold water side heat source supply line 121.

A flow rate sensor 841 and a temperature sensor 842 are arranged upstream of the intercooler 64 along the first equipment heat cooling line 126, while a temperature sensor 843 and a valve 317 are arranged downstream of the intercooler 64. The flow rate sensor 841 measures the flow rate of the heat medium before exchanging heat with the intercooler 64, and outputs the measurement results to the control device 90. The temperature sensor 842 measures the temperature of the heat medium before exchanging heat with the intercooler 64, and outputs the measurement results to the control device 90. The temperature sensor 843 measures the temperature of the heat medium after exchanging heat with the intercooler 64, and outputs the measurement results to the control device 90.

The second equipment heat cooling line 127 has the upstream end thereof connected to the cold water side heat source return line 122, and the downstream end thereof connected to the cold water side heat source supply line 121. In the present embodiment, the upstream end of the second equipment heat cooling line 127 is connected between the valve 310 and the valve 311 along the cold water side heat source return line 122. The downstream end of the second equipment heat cooling line 127 is connected between the valve 307 and the cold water side circulation pump 821 along the cold water side heat source supply line 121, and is located upstream of the connection point of the downstream end of the first equipment heat cooling line 126.

The second equipment heat cooling line 127 of the present embodiment includes: a first branch line 127a for cooling the vacuum pump 62; and a second branch line 127b for cooling the carbon dioxide recovery pump 63.

The first branch line 127a is connected to the vacuum pump 62, and cools the vacuum pump 62 using cold water. The heat medium, in the state of being heated through heat exchange with the vacuum pump 62, merges with the second branch line 127b and is sent to the cold water side heat source supply line 121.

A flow rate sensor 851 and a temperature sensor 852 are arranged upstream of the vacuum pump 62 along the first branch line 127a, while a temperature sensor 853 is arranged downstream of the vacuum pump 62. The flow rate sensor 851 measures the flow rate of the heat medium before exchanging heat with the vacuum pump 62, and outputs the measurement results to the control device 90. The temperature sensor 852 measures the temperature of the heat medium before exchanging heat with the vacuum pump 62, and outputs the measurement results to the control device 90. The temperature sensor 853 measures the temperature of the cold water after exchanging heat with the vacuum pump 62, and outputs the measurement results to the control device 90.

The second branch line 127b is connected to the carbon dioxide recovery pump 63, and cools the carbon dioxide recovery pump 63 using the heat medium. The heat medium, in the state of being heated through heat exchange with the carbon dioxide recovery pump 63, merges with the first branch line 127a and is sent to the cold water side heat source supply line 121.

A flow rate sensor 861 and a temperature sensor 862 are arranged upstream of the carbon dioxide recovery pump 63 along the second branch line 127b, while a temperature sensor 863 is arranged downstream of the carbon dioxide recovery pump 63. The flow rate sensor 861 measures the flow rate of the heat medium before exchanging heat with the carbon dioxide recovery pump 63, and outputs the measurement results to the control device 90. The temperature sensor 862 measures the temperature of the heat medium before exchanging heat with the carbon dioxide recovery pump 63, and outputs the measurement results to the control device 90. The temperature sensor 863 measures the temperature of the heat medium after exchanging heat with the carbon dioxide recovery pump 63, and outputs the measurement results to the control device 90.

An equipment cooling pump 870 is arranged upstream of the branching point between the first branch line 127a and the second branch line 127b along the second equipment heat cooling line 127. Valves 318 and 319 are arranged downstream of the merging point between the first branch line 127a and the second branch line 127b along the second equipment heat cooling line 127.

The equipment cooling pump 870 in the present embodiment is configured by a cascade pump with a sufficient pump head to pump the heat medium without being hindered by the high pressure losses of the vacuum pump 62 and the carbon dioxide recovery pump 63, which are the target equipment for heat recovery. The exhaust heat generated by operating the equipment cooling pump 870 is also recovered through cold water.

As described above, the equipment heat recovery circuit 87 can recover steam condensation heat from the intercooler 64 and exhaust heat from the vacuum pump 62 and the carbon dioxide recovery pump 63 into the heat medium, thereby cooling the target equipment, and introduce the heat medium into the heat source device 81 at a higher temperature potential through heat recovery.

The equipment heat recovery circuit 87 cools the target equipment, including the vacuum pump 62, the carbon dioxide recovery pump 63, and the intercooler 64, using the low-temperature heat medium cooled by the heat source device 81. The cold water, which has recovered exhaust heat by cooling the target equipment (vacuum pump 62, carbon dioxide recovery pump 63, and intercooler 64), merges with the cold water side heat source supply line 121, through which the cold water discharged from the cold water tank 82 (e.g., from the upper layer of the cold water tank 82 where the temperature is higher) circulates, and is introduced into the heat source device 81. The cold water having recovered exhaust heat is heated to a temperature in an appropriate range.

In the present embodiment, the radiator bypass line 123 for cooling the cold water, or the heater bypass line 124 for heating the cold water, adjusts the temperature to an appropriate range before the heat medium enters the heat source device 81. This adjustment smooths the thermal fluctuations over time, even during operations with significant heat load variations, thereby allowing for stabilizing the inlet temperature of the heat source device 81.

Next, the configuration of the reservoir tank 88 will be described. The reservoir tank 88 is a tank capable of storing the heat medium. The reservoir tank 88 is connected to the hot water tank 83 and the cold water tank 82. A valve 320 is arranged between the reservoir tank 88 and the hot water tank 83, and a valve 321 is arranged between the reservoir tank 88 and the cold water tank 82. When the amount of storing the heat medium stored in the hot water tank 83 needs to be adjusted, the valve 320 opens to transfer the heat medium between the reservoir tank 88 and the hot water tank 83. Similarly, when the storage amount of the heat medium stored in the cold water tank 82 needs to be adjusted, the valve 321 opens to transfer the heat medium between the reservoir tank 88 and the cold water tank 82. A level sensor 880 for monitoring the storage amount is arranged inside the reservoir tank 88. The measurement results from the level sensor 880 are output to the control device 90. The control device 90 uses the measurement results from the level sensor 880 to determine the availability of the reservoir tank 88.

### <Equipment Heat Recovery Control>

The control device 90 obtains the output signals from the flow rate sensor 231 and the temperature sensor 232 to monitor the flow rate and temperature of the hot water flowing into the heat source device 81, and obtains the output signals from the flow rate sensor 131 and the temperature sensor 132 to monitor the flow rate and temperature of the cold water flowing into the heat source device 81.

The control device 90 monitors the flow rate, the inlet temperature, and the outlet temperature of the cold water flowing into the target equipment. More specifically, the control device 90 obtains the output signals from the flow rate sensor 841, the temperature sensor 842, and the temperature sensor 843 to monitor the flow rate and temperature of the cold water flowing into the intercooler 64, and obtains the outlet temperature of the cold water after cooling the intercooler 64. The control device 90 also obtains the output signals from the flow rate sensor 851, the temperature sensor 852, and the temperature sensor 853 to monitor the flow rate and temperature of the cold water flowing into the vacuum pump 62, and obtains the outlet temperature of the cold water after cooling the vacuum pump 62. The control device 90 obtains the output signals from the flow rate sensor 861, the temperature sensor 862, and the temperature sensor 863 to monitor the flow rate and temperature of the cold water flowing into the carbon dioxide recovery pump 63, and obtains the outlet temperature of the cold water after cooling the carbon dioxide recovery pump 63.

Based on the various monitoring results, the control device 90 executes open/close control and flow rate adjustment control of the valves 301 to 321. For example, in a case where the temperature of the cold water flowing into the heat source device 81 is low, the valves 317 to 319 are controlled to increase the amount of cold water flowing into the target equipment (vacuum pump 62, carbon dioxide recovery pump 63, and intercooler 64), thereby increasing the temperature of the cold water. In this case, the flow rate control or the open/close control is preferably executed to ensure that the temperature remains within the desired temperature range that is set for the target equipment.

As described above, the carbon dioxide recovery apparatus 1 of the present embodiment further includes the control device 90 that controls the path of the equipment heat recovery circuit 87 to ensure that the temperature of the cooling heat medium flowing into the heat source device 81 is within a preset appropriate range.

This allows for responding to heat fluctuations caused by changes in the external environment, thereby realizing the configuration of the more energy-efficient carbon dioxide recovery apparatus 1.

In the present embodiment, the valves 301 to 321 are automatically controlled by the control device 90. However, in the case of not executing automatic control, manually operated valves may be used.

As described above, the carbon dioxide recovery apparatus 1 of the present embodiment includes: the plurality of modules 11 that internally include the adsorbent 12 and execute an absorbing step of absorbing carbon dioxide onto the adsorbent 12 by drawing a gas containing carbon dioxide, and a desorbing step of desorbing carbon dioxide from the adsorbent 12 by heating the adsorbent 12 under reduced ambient pressure; the heat pump-type heat source device 81 that heats hot water and cools cold water; and the heat exchange device 70 that includes the hot water line (heating heat medium line) 112 for supplying and heating hot water (heating heat medium) to each module 11, and the cold water line (cooling heat medium line) 111 for supplying and cooling cold water (cooling heat medium) to each module 11. The heat exchange device 70 includes: the heat source high-temperature water circuit 85 that includes the hot water tank (heating heat medium tank) 83 that stores hot water heated by the heat source device 81, and circulates the hot water between the hot water tank 83 and the heat source device 81; the heat source low-temperature water circuit 86 that includes the cold water tank (cooling heat medium tank) 82 that stores cold water cooled by the heat source device 81, and circulates the cold water between the cold water tank 82 and the heat source device 81; and the equipment heat recovery circuit 87, which branches from the heat source low-temperature water circuit 86, connects to the inlet side of the heat source device 81 of the heat source low-temperature water circuit 86 through the target equipment (such as the vacuum pump 62, the carbon dioxide recovery pump 63, and the intercooler 64) for executing the absorbing step and the desorbing step, and returns the cold water having recovered exhaust heat from the target equipment, to the heat source device 81.

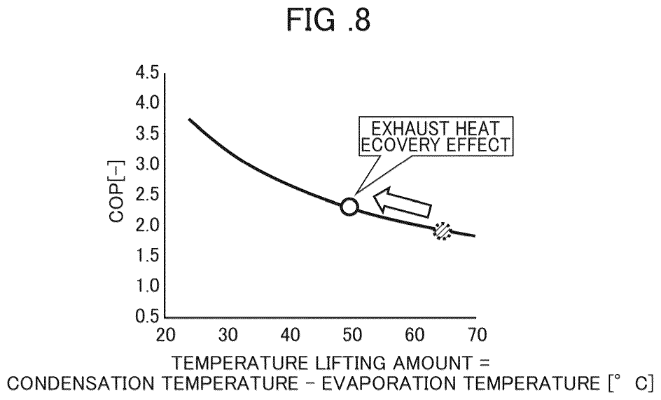

As a result, high-temperature heat can be generated simultaneously with cooling the target equipment, while reducing the temperature difference in the heat source device 81 through the effect of recovering exhaust heat with the equipment heat recovery circuit 87. This allows for achieving a high coefficient of performance (COP) and suppressing the required power consumption. FIG. 8 is a schematic graph illustrating the relationship between the temperature difference in the heat medium introduced into the heat source device 81 and the coefficient of performance (COP). As illustrated in FIG. 8, the larger the temperature difference between the high-temperature heat medium and the low-temperature heat medium introduced into the heat source device 81, the lower the COP becomes. For example, in a case where heat exchange occurs between the high-temperature heat medium and the low-temperature heat medium in an environment where the outside air temperature is low, the temperature difference between the high-temperature heat medium and the low-temperature heat medium increases, resulting in a decrease in the COP. In this respect, according to the configuration of the present embodiment, the target equipment can be cooled using the low-temperature heat medium, and the heat medium heated through this cooling process can be introduced into the low-temperature side of the heat source device 81, thereby allowing for improving the COP.

In the present embodiment, the cold water having recovered exhaust heat by cooling the modules 11 is returned to the inlet side of the heat source device 81 via the cold water tank 82.

As a result, the temperature of the cold water flowing into the heat source device 81 can be raised using the exhaust heat generated during the cooling process of the modules 11, allowing for efficiently improving the COP.

The carbon dioxide recovery apparatus 1 of the present embodiment further includes the equipment cooling pump 870 serving as a cascade pump that sends the cooling heat medium to the inlet side of the heat source device 81.

Since the cascade pump generates more heat than other types of pumps, the exhaust heat generated by the equipment cooling pump 870 itself can also be used to efficiently heat the cold water flowing into the heat source device 81.

In the present embodiment, the equipment heat recovery circuit 87 is configured such that the target equipment (such as the vacuum pump 62, the carbon dioxide recovery pump 63, and the intercooler 64) is arranged in each of the plurality of paths (the first equipment heat cooling line 126 and the second equipment heat cooling line 127) branched from the heat source low-temperature water circuit 86, and cold water having recovered exhaust heat from each target equipment is collected and returned to the heat source device 81.

As a result, each target equipment can be cooled to an appropriate temperature, while recovering exhaust heat, enabling more energy-efficient system operation.

In the above embodiment, the target equipment, including the vacuum pump 62, the carbon dioxide recovery pump 63, and the intercooler 64, is arranged in parallel on the equipment heat recovery circuit 87. However, the configuration is not limited to such an arrangement. The target equipment may also be arranged in series on the equipment heat recovery circuit 87. In the case of arranging the pieces of target equipment in series on the equipment heat recovery circuit 87, and for example, in a case where the steam of the intercooler 64 can be condensed by the heat medium having recovered heat, then the vacuum pump 62 and the carbon dioxide recovery pump 63 may be arranged upstream, while the intercooler 64 may be arranged downstream. This configuration first cools the vacuum pump 62 and the carbon dioxide recovery pump 63, which require a lower-temperature heat medium compared to the intercooler 64, whereby the heat medium having cooled the vacuum pump 62 and the carbon dioxide recovery pump 63 can subsequently cool the intercooler 64 as well. By supplying a low-temperature heat medium preferentially to the target equipment that requires the lowest cooling temperature, sufficient cooling performance can be achieved. This configuration also allows the heat medium heated by cooling the intercooler 64 to be introduced to the inlet side of the heat source device 81.

The embodiments of the present invention have been described above; however, the present invention is not limited to the above-described embodiments and modified examples. The effects described in the above embodiments are merely examples of preferred effects, and the invention is not limited to those described in the embodiments.

### EXPLANATION OF REFERENCE NUMERALS

1: carbon dioxide recovery apparatus
11: module
12: adsorbent
62: vacuum pump (target equipment)
63: carbon dioxide recovery pump (target equipment)
64: intercooler (target equipment)
70: heat exchange device
80: heat source circuit
81: heat source device
82: cold water tank (cooling heat medium tank)
83: hot water tank (heating heat medium tank)
85: heat source high-temperature water circuit
86: heat source low-temperature water circuit
87: equipment heat recovery circuit
90: control device
111: cold water line (cooling heat medium line)
111a: cold water supply line (cooling heat medium supply line)
111b: cold water return line (cooling heat medium return line)
112: hot water line (heating heat medium line)
112a: hot water supply line (heating heat medium supply line)
112b: hot water return line (heating heat medium return line)
870: equipment cooling pump (cascade pump)

What is claimed is:

1. A carbon dioxide recovery apparatus, comprising:
a plurality of modules that each internally include an adsorbent and are configured to execute an absorbing step of absorbing carbon dioxide onto the adsorbent by drawing a gas containing carbon dioxide, and a desorbing step of desorbing the carbon dioxide from the adsorbent by heating the adsorbent under reduced ambient pressure; and
a heat exchanger that includes a heat pump-type heat source that heats a heating heat medium and cools a cooling heat medium, a heating heat medium line configured to supply and heat the heating heat medium to each of the modules, and a cooling heat medium line configured to supply and cool the cooling heat medium to each of the modules,
wherein the heat exchanger includes:
a heat source high-temperature water circuit that includes a heating heat medium tank to store the heating heat medium heated by the heat source, and circulates the heating heat medium between the heating heat medium tank and the heat source;
a heat source low-temperature water circuit that includes a cooling heat medium tank configured to store the cooling heat medium cooled by the heat source, and circulates the cooling heat medium between the cooling heat medium tank and the heat source; and
an equipment heat recovery circuit that branches from the heat source low-temperature water circuit, passes through target equipment for executing the absorbing step or the desorbing step, connects to an inlet side of the heat source within the heat source low-temperature water circuit, and returns the cooling heat medium having recovered exhaust heat from the target equipment, to the heat source.

2. The carbon dioxide recovery apparatus according to claim 1, wherein the cooling heat medium having recovered exhaust heat by cooling the modules is returned to an inlet side of the heat source via the cooling heat medium tank.

3. The carbon dioxide recovery apparatus according to claim 1, further comprising a cascade pump that sends the cooling heat medium to an inlet side of the heat source.

4. The carbon dioxide recovery apparatus according to claim 1, wherein
the equipment heat recovery circuit includes the target equipment arranged along each of a plurality of paths branched from the heat source low-temperature water circuit, and
the equipment heat recovery circuit collects and returns the cooling heat medium having recovered exhaust heat from each of the plurality of target equipment, to the heat source.

5. The carbon dioxide recovery apparatus according to claim 1, further comprising a controller configured to control a path of the equipment heat recovery circuit, such that temperature of the cooling heat medium flowing into the heat source falls within a preset appropriate range.
